(19) United States
(12) Patent Application Publication
(10) Pub. No.: US 2009/0237410 A1
(43) Pub. Date: Sep. 24, 2009

(54) SYSTEM AND METHOD FOR OFFSET CURVES WITH BIDIRECTIONAL CONSTRAINTS

(76) Inventors: Dick Baardse, Herogenbosh (NL); Manoj Radhakrishnan, Cypress, CA (US)

Correspondence Address: Siemens Corporation;Intellectual Property Department, 170 Wood Avenue South, Iselin, NJ, 08830, US

(21) Appl. No.: 12/052,660

(22) Filed: Mar. 20, 2008

(51) Int. Cl. G06T 11/20

(52) U.S. Cl. 345/442

(57) ABSTRACT

A system, method, and computer program for editing curves having bidirectional offset constraints, comprising selecting a collection of curves having a set of curve end points to perform an operation; and constraining a set of offset end points to said set of curve end points; whereby end constraints for offset curves are known, and appropriate means and computer-readable instructions.

### CROSS-REFERENCE TO RELATED APPLICATIONS

This application is related to U.S. Ser. No. 12/052,610, entitled “SYSTEM AND METHOD FOR A FULLY EDITABLE OPERATION IN THE CONTEXT OF A SOLVER CONTROLLED ENVIRONMENT”. filed on Mar. 20, 2008 (even date herewith), which application is incorporated by reference here.

### TECHNICAL FIELD

The presently preferred embodiment of the innovations described herein relate generally to software applications. More specifically, the presently preferred embodiment relates to fully editable operation in the context of a constraint system.

### BACKGROUND

In the art of computer aided design (CAD) software systems, offset functionality in a constraint controlled environment is often limited to the creation of curves. After those curves have been created, the only way to modify the result is by interacting with the curves of the constraints. Further, offsetting multiple disconnected closed or open looks is often not possible or directional side controls are not available for separated chains.

Creating offset curves in a constraint controlled environment like a sketch in a CAD system often leads to results where the offset curves are not handled well during modification. The way in which such curves behave after trimming and extending is often unpredictable. Some solutions exist where copies of curves are created and the original curves are then hidden from the user—these situations lead to complicated sketches.

What is needed is a system and method that allows the original curves and the created offset curves to be trimmed and extended without copying while preserving predictable behavior.

### SUMMARY

To achieve the foregoing, and in accordance with the purpose of the presently preferred embodiment as described herein, the present application provides a computer implemented method for editing curves having bidirectional offset constraints, comprising selecting a collection of curves having a set of curve end points to perform an operation; and constraining a set of offset end points to said set of curve end points; whereby end constraints for offset curves are known. The method, wherein said collection of curves is in two-dimensional space. The method, wherein said end constraints are in one of an on state or an off state. The method, wherein said collection of curves has a meeting point of at least two chains of curves. The method, wherein said operation selects said collection of curves at said meeting point. The method, wherein said operation is one of a joining operation and a separating operation. The method, wherein said operation forms a corner treatment. The method, wherein said operation is one of a trimming operation, an extending operation, and a deleting operation. The method, wherein said deleting operation removes a base curve and a corresponding offset curve. The method, wherein said deleting operation breaks said corresponding offset curve into at least two sub-loops. The method, further comprising defining a plurality of connected segments from said collections of curves. The method, wherein said plurality of connected segments are offset in a same direction.

An advantage of the presently preferred embodiment is to provide a computer-program product tangibly embodied in a machine readable medium to perform a method for editing curves having bidirectional offsets, comprising instructions operable to cause a computer to select a collection of curves having a set of curve end points to perform an operation; and constrain a set of offset end points to said set of curve end points; whereby end constraints for offset curves are known. The computer-program product, wherein said collection of curves is in two-dimensional space. The computer-program product, wherein said end constraints are in one of an on state or an off state. The computer-program product, wherein said collection of curves has a meeting point of at least two chains of curves. The computer-program product, wherein said operation selects said collection of curves at said meeting point. The computer-program product, wherein said operation is one of a joining operation and a separating operation. The computer-program product, wherein said operation forms a corner treatment. The computer-program product, wherein said operation is one of a trimming operation, an extending operation, and a deleting operation. The computer-program product, wherein said deleting operation removes a base curve and a corresponding offset curve. The computer-program product, wherein said deleting operation breaks said corresponding offset curve into at least two sub-loops. The computer-program product, further comprising defining a plurality of connected segments from said collections of curves. The computer-program product, wherein said plurality of connected segments are offset in a same direction.

Another advantage of the presently preferred embodiment is to provide a data processing system having at least a processor and accessible memory to implement a method for editing curves having bidirectional offsets, comprising means for selecting a collection of curves having a set of curve end points to perform an operation; and means for constraining a set of offset end points to said set of curve end points.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a logic flow diagram of the method employed by the presently preferred embodiment;

FIG. 2 illustrates an example of an offset operation without section segmentation;

FIG. 3 illustrates an example of an offset operation with section segmentation;

FIG. 4 illustrates an example of an offset operation with corner treatments;

FIG. 5 illustrates an example of an offset operation with end constraints;

FIG. 6 illustrates a trimming and extending curves example interacting with an offset; and

FIG. 7 is a block diagram of a computer environment in which the presently preferred embodiment may be practiced.

### DETAILED DESCRIPTION OF THE PREFERRED EMBODIMENTS

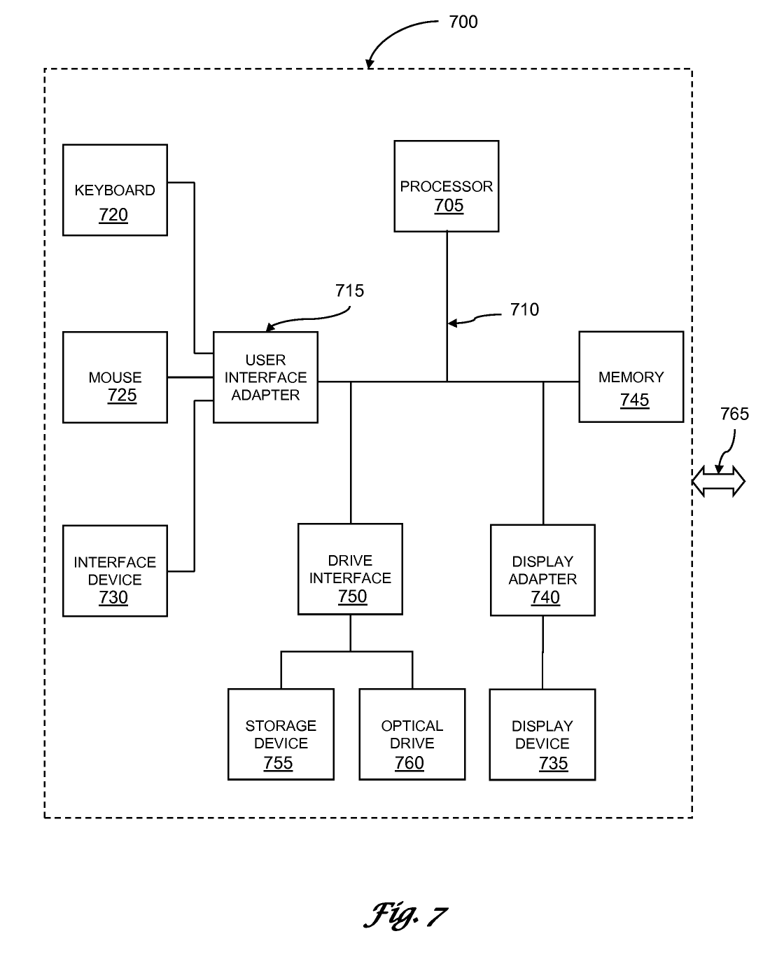

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method for offset curves in a bidirectional constraint system. Now therefore, in accordance with the presently preferred embodiment, an operating system executes on a computer, such as a general-purpose personal computer. FIG. 7 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implement particular abstract data types. The presently preferred embodiment may be performed in any of a variety of known computing environments.

Referring to FIG. 7, an exemplary system for implementing the presently preferred embodiment includes a general-purpose computing device in the form of a computer 700, such as a desktop or laptop computer, including a plurality of related peripheral devices (not depicted). The computer 700 includes a microprocessor 705 and a bus 710 employed to connect and enable communication between the microprocessor 705 and a plurality of components of the computer 700 in accordance with known techniques. The bus 710 may be any of several types of bus structures including a memory bus or memory controller, a peripheral bus, and a local bus using any of a variety of bus architectures. The computer 700 typically includes a user interface adapter 715, which connects the microprocessor 705 via the bus 710 to one or more interface devices, such as a keyboard 720, mouse 725, and/or other interface devices 730, which can be any user interface device, such as a touch sensitive screen, digitized pen entry pad, etc. The bus 710 also connects a display device 735, such as an LCD screen or monitor, to the microprocessor 705 via a display adapter 740. The bus 710 also connects the microprocessor 705 to a memory 745, which can include ROM, RAM, etc.

The computer 700 further includes a drive interface 750 that couples at least one storage device 755 and/or at least one optical drive 760 to the bus. The storage device 755 can include a hard disk drive, not shown, for reading and writing to a disk, a magnetic disk drive, not shown, for reading from or writing to a removable magnetic disk drive. Likewise the optical drive 760 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 700.

The computer 700 can communicate via a communications channel 765 with other computers or networks of computers. The computer 700 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 745 of the computer 700. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

### System

The implementation of the presently preferred embodiment requires the use of a constraint system that can come in form of an application, such as PGM and DCM offered by Siemens Product Lifecycle Management Software, Inc. (Plano, Tex.), or other geometric modelers and constraint solver systems, which is designed to provide functions to support the development of CAD systems for geometric construction of parts using constraints. The geometric entities managed by PGM and DCM may have dimensional constraints (distance, angle, radius, etc.) or logical constraints (perpendicularity, parallelism, coincidence, etc.) among them. A feature common to CAD applications is the ability to offset an object by first defining a reference point, and then calculating an offset distance from the reference point. When using the constraint solver, there is the intent to maintain the desired spatial relations asserted when the constraints were formed. Example functions provided by constraint solvers, including those provided by DCM, allow offset constraints to have disjoint chains and support end constraints when solving.

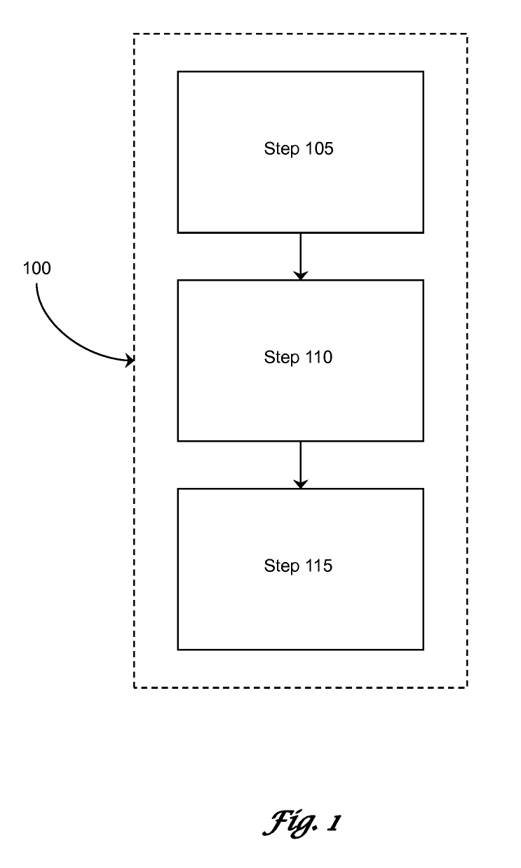

FIG. 1 is a logic flow diagram of the method employed by the presently preferred embodiment. Referring to FIG. 1, a computer implemented method 100 for editing curves offset curves with bidirectional offset constraints is employed. Begin by selecting a collection of curves having a set of curve end points (Step 105). Next, operate on the collection of curves to perform an offset (Step 110). And then, constrain the set of offset end points to the set of curve end points (Step 115), so that end constraints for offset curves are known.

### Section Segmentation

An offset operation initiated by a user but calculated and executed by a computer aided drafting (CAD) application in a manner well understood in the art, allows offsetting of curves in a 2D plane. The collection of curves that is selected to be offset is referred to as a section. The section can consist of several connected chains of curves. A chain of curves is a number of connected curves that are offset in the same direction. The offset command allows the user to have full control over the section segmentation of the contour that is offset. First, the user defines the chains with several connected segments, after every selection the user can choose to start a completely new segment. And second, the user defines the chains by creating and editing of the offset so that the user can join or separate chains by picking locations where two chains meet.

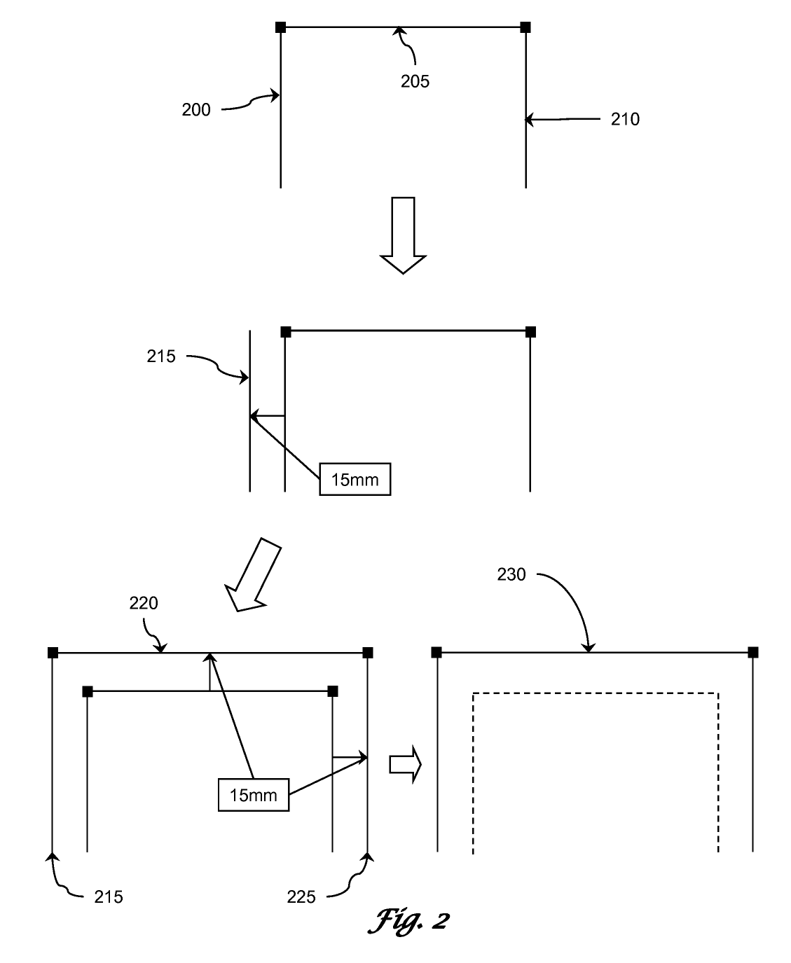

During creation of offsets, the user can offset multiple curves. By default, the creation operation collects the selected curves in a minimal number of connected chains, if possible. However, at any time the user can start a new segment. FIG. 2 illustrates an example of an offset operation without section segmentation. Referring to FIG. 2, the user begins with 3 curves denoted by a first curve 200, a second curve 205, and third curve 210. The user then intends to perform the offset operation to move the 3 curves, 200, 205, 210, outward by 15 millimeters. The user selects the first curve 200, inputs the offset distance of 15 mm, and views a first curve offset preview 215. The user then proceeds to select the second curve 205 and then the third curve 210 that result in a second curve offset preview 220 and a third curve offset preview 225. The offset operation collects all three curves, 200, 205, 210, respectively, in a single chain 230. The two corners internal to the single chain 230 are illustrated as closed, but can alternatively be fillet.

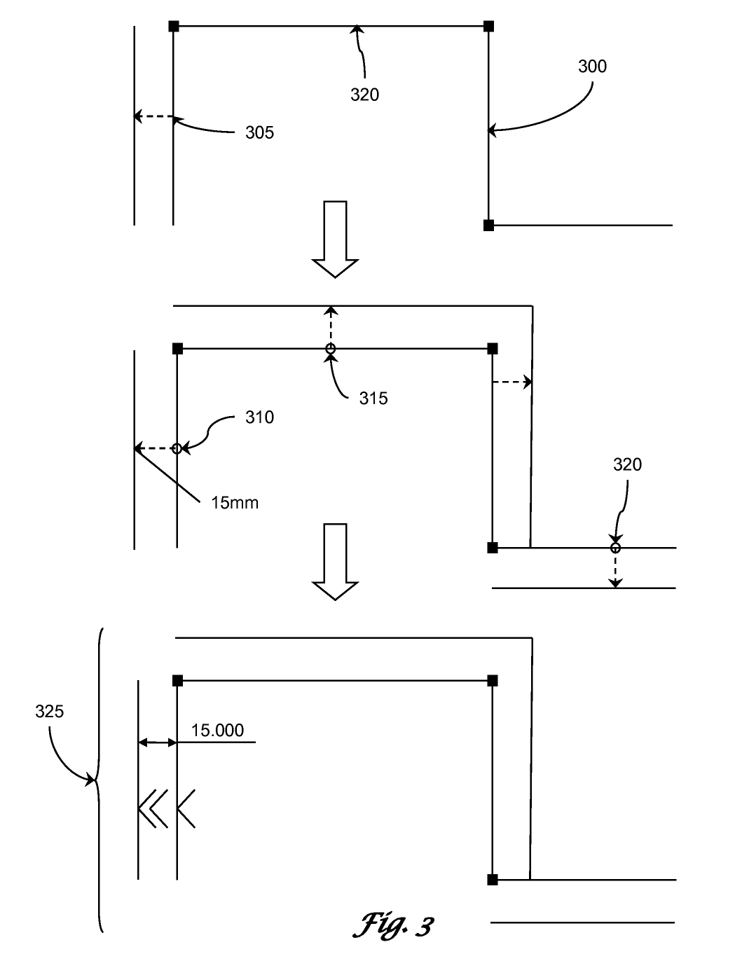

The prior example illustrates the offset operation without section segmentation. FIG. 3 illustrates an example of an offset operation with section segmentation. Referring to FIG. 3, the control of segmentation of a single chain 300 of curves allows the user to break the single chain 300 during selection. The “select curve” feature of the offset operation supports the user's intent to define an offset with different directions. The user selects, in this example, a first curve 305 to offset by a distance of 15 mm. Then, the user decides to end the single chain 300, thereby forming a first chain 310 and start a new chain. In the presently preferred embodiment, the user's intent may be initiated by a mouse gesture (or dialog box option, or some other method, for example). The user selects a second curve 315 to offset resulting in a visual indicator, for example, a different colored curve such as cyan. The visual indicator aids the user by distinguishing a curve on one chain from another curve on another chain. The new chain has its own separate offset direction control, where each individual curve can be horizontally or vertically flipped, depending upon design intent. Optionally, the user can determine to start another new chain 320, the end result of all of these offset operations can be several joined and disjoined chains that are offset, as generally illustrated at 325.

### Joining and Splitting of Chains

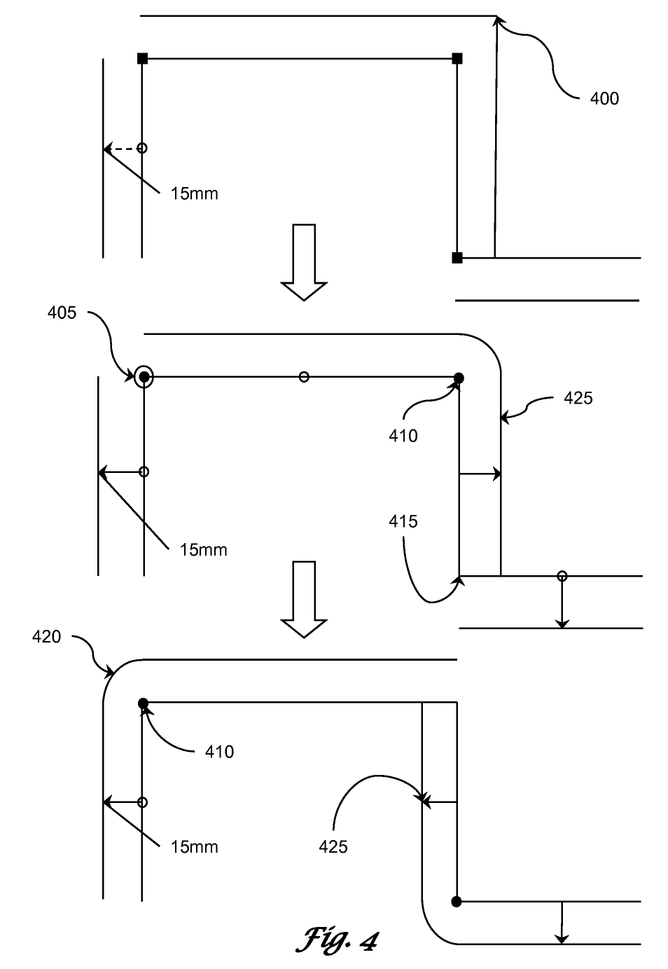

Joining and separating chains is important because in some cases the user wants corner treatments (Arc Cap or Curve Extension) which are only available on corners that are internal to a chain. In other cases the user might prefer to have open ends. The ability to join of separate chains is available during creation and editing. During the creation and editing of the offset curves, the chains can be joined or split. This action is also referred to as the closing or opening of corners, respectively. Editing an offset curve involves first editing the offset, because the offset curve is dependent upon the offset operation. FIG. 4 illustrates an example of an offset operation with corner treatments. Referring to FIG. 4, when the offset operation from the prior example (see FIG. 3) is edited, a corner treatment 400 can be set from closed to Arc or Fillet operation. Regardless, the corner treatment 400 only shows for closed corners. In the presently preferred embodiment, to indicate which corners are closed, and which are not, the user may turn-on a display feature of chain end symbols that displays a number of spherical symbols on the original curves that indicate an open or closed end, such as a halo sphere 405, i.e., a sphere with a circle, that indicates this particular corner is open and marks the corner where two connected chains meet. A corner sphere 410 indicates that the closed corner is between two curves of the same chain. A corner 415 with neither the sphere nor the halo sphere indicates the ends of two chains where the offsets are not in the same direction. With these display features, the user will know which corners are open, as open corners can only be closed, i.e., chains can only be merged, when the offset on both chains is in the same direction. Of course, a corner can also be at the meeting ends of collinear lines. The user can interact with the symbols and directions to open or close corners. For example, a top left corner 420 is closed by an arc. Next, a top right corner is opened and a right vertical chain 425 is reversed, which would also result in a bottom right open corner to appear (not depicted). Now the bottom right open corner can be closed because the curves are offset in the same direction.

### End Constraints

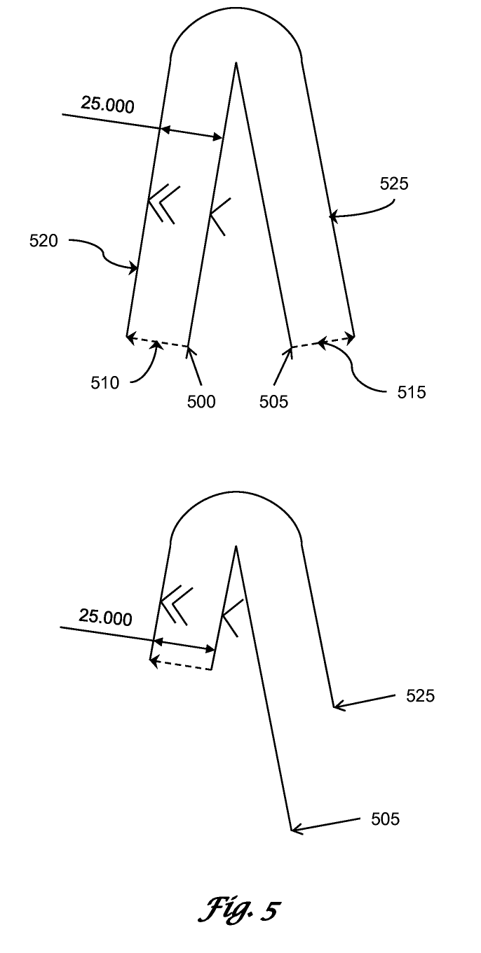

The offset operation creates additional end constraints which are related to the offset constraints. The end constraints are automatically defined utilizing techniques understood in the CAD industry and common enough CAD applications that further discussion is not necessary. These constraints are added in order to keep the end points of the offset curve result close to the end points of the original curves. Without the end constraints the offset curves become unpredictable as seen in like in other CAD systems. End constraints exist on all open ends of chain within the section of an offset constraint. End constraints can have two values On or Off. FIG. 5 illustrates an example of an offset operation with end constraints. Referring to FIG. 5, when an offset is created with a first chain 500 and a second chain 505 for the distance of 25 mm, the open end of the first chain 500 and the open end of the second chain 505, have a first end constraint 510 and a second end constraint 515, respectively. The user can delete the end constraints like any other constraint. In the presently preferred embodiment, when the end constraint is ON a visual indicator is shown, like the arrows at 510 and 515. The constraint will then constrain the end point of a first offset curve 520 perpendicular to a chain end location. Put another way, if the offset end point or the original end point are moved, those two points will always be at the offset distance and are constrained to one another. After deleting one of the end constraints, the behavior of the constraints illustrates that the ends of the first chain and the first offset curve 520 stay close and behave as constrained. However, where the constraint is turned off, the ends of the second chain 505 and a second offset curve 525 will be further apart. The curves and chains can be merged after the user turns both end constraints ON.

### Impact of Curve Modifications

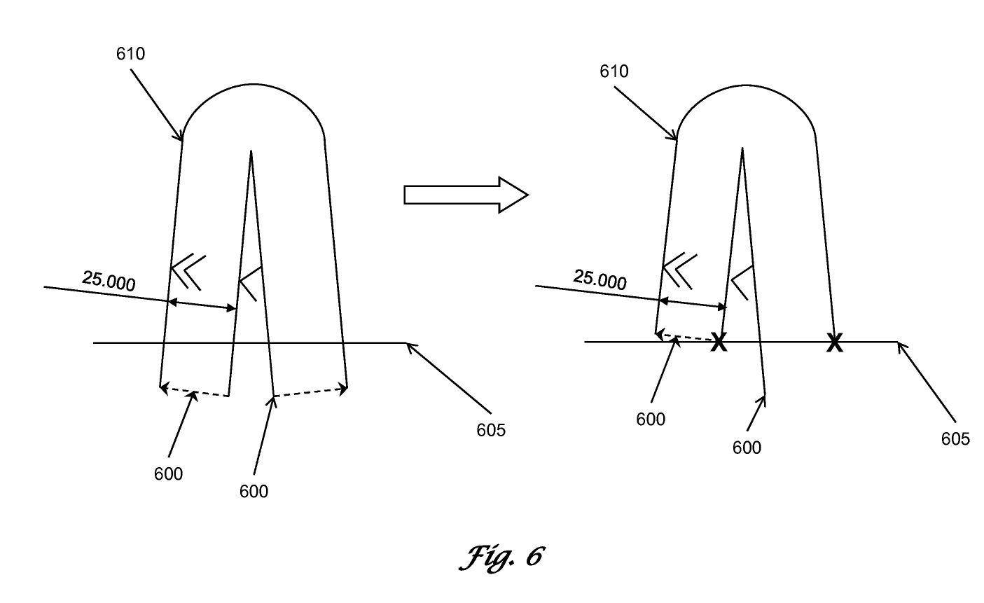

In order to use the offset curves for building engineering sections other operations might be carried out on the outcome of the offset operation. Examples of these other operations: trimming, extending, and make corner operation on input and output curves. There can be more examples, like fillet of original input curves; deleting a curve that was used as input for an offset. Additional special behavior has been designed for curve modifications. The deleting behavior for the curve involves, where the base curve is deleted, then delete the corresponding offset curve and break the offset into two sub-loops. Put another way, deleting the offset curve is preferably equivalent to editing the offset and removing the corresponding based curve from it. FIG. 6 illustrates a trimming and extending curves example interacting with an offset. Referring to FIG. 6, an original curve 600 of the chain is trimmed to a line 605. The trimming leads to a situation where an offset curve 610 moves with the original curve 600, where an end constraint 615 remains in an “ON” state, generally shown by a dashed-arrow at 615. When the offset curve 610 is trimmed with the line 605, the end constraint 615 is removed or set to an “OFF” state (or status). The same rule is used when extending curves or making corners. When filleting two curves that are offset as part of a single chain the new fillet arc is added to the chain and offset. When filleting is applied to the offset curves, that action edits the offset segment. The user creates an offset of a single chain of curves where the user now fillets the corners of the offset curves, breaking the offset segment. Where the offset is filleted, the chain is opened and the end constraints are turned off (the location of the end points is defined by the fillet). Note that the chains can be merged after the user turns both end constraints to the ON state (or status).

### Conclusion

The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be an assembled, compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application2-specific integrated circuits).

A number of embodiments have been described. It will be understood that various modifications may be made without departing from the spirit and scope of the presently preferred embodiment, such as when trimming or extending curves, etc. While the presently preferred embodiment is directed to 2D, the same can be said for 3D and other dimensions. Therefore, other implementations are within the scope of the following claims.

What is claimed is:

1. A computer implemented method for editing curves having bidirectional offset constraints, comprising:
selecting a collection of curves having a set of curve end points to perform an operation; and
constraining a set of offset end points to said set of curve end points;
whereby end constraints for offset curves are known.

2. The method of claim 1, wherein said collection of curves is in two-dimensional space.

3. The method of claim 1, wherein said end constraints are in one of an on state or an off state.

4. The method of claim 1, wherein said collection of curves has a meeting point of at least two chains of curves.

5. The method of claim 1, wherein said operation selects said collection of curves at said meeting point.

6. The method of claim 1, wherein said operation is one of a joining operation and a separating operation.

7. The method of claim 1, wherein said operation forms a corner treatment.

8. The method of claim 1, wherein said operation is one of a trimming operation, an extending operation, and a deleting operation.

9. The method of claim 8, wherein said deleting operation removes a base curve and a corresponding offset curve.

10. The method of claim 9, wherein said deleting operation breaks said corresponding offset curve into at least two sub-loops.

11. The method of claim 1, further comprising defining a plurality of connected segments from said collections of curves.

12. The method of claim 11, wherein said plurality of connected segments are offset in a same direction.

13. A computer-program product tangibly embodied in a machine readable medium to perform a method for editing curves having bidirectional offsets, comprising instructions operable to cause a computer to:
select a collection of curves having a set of curve end points to perform an operation; and
constrain a set of offset end points to said set of curve end points;
whereby end constraints for offset curves are known.

14. The computer-program product of claim 13, wherein said collection of curves is in two-dimensional space.

15. The computer-program product of claim 13, wherein said end constraints are in one of an on state or an off state.

16. The computer-program product of claim 13, wherein said collection of curves has a meeting point of at least two chains of curves.

17. The computer-program product of claim 13, wherein said operation selects said collection of curves at said meeting point.

18. The computer-program product of claim 13, wherein said operation is one of a joining operation and a separating operation.

19. The computer-program product of claim 13, wherein said operation forms a corner treatment.

20. The computer-program product of claim 13, wherein said operation is one of a trimming operation, an extending operation, and a deleting operation.

21. The computer-program product of claim 20, wherein said deleting operation removes a base curve and a corresponding offset curve.

22. The computer-program product of claim 21, wherein said deleting operation breaks said corresponding offset curve into at least two sub-loops.

23. The computer-program product of claim 13, further comprising defining a plurality of connected segments from said collections of curves.

24. The computer-program product of claim 23, wherein said plurality of connected segments are offset in a same direction.

25. A data processing system having at least a processor and accessible memory to implement a method for editing curves having bidirectional offsets, comprising:
means for selecting a collection of curves having a set of curve end points to perform an operation; and
means for constraining a set of offset end points to said set of curve end points.
